(19) United States
(12) Patent Application Publication
(10) Pub. No.: US 2021/0256520 A1
(43) Pub. Date: Aug. 19, 2021

(54) AUTOMATED MOTOR VEHICLE DEPARTMENT TRANSACTION SYSTEMS AND METHODS

(71) Applicant: MVD Specialists, LLC, Albuquerque, NM (US)

(72) Inventors: James Scott Baird, Albuquerque, NM (US); Justin Scott Baird, Albuquerque, NM (US)

(73) Assignee: MVD Now, Albuquerque, NM (US)

(21) Appl. No.: 16/789,885

(22) Filed: Feb. 13, 2020

(51) Int. Cl. G06Q 20/40; G06Q 20/32; G06Q 30/06; G06Q 30/00; G06Q 20/18

(52) U.S. Cl. CPC G06Q 20/4014; G06Q 20/3224; G06Q 20/18; G06Q 30/01; G06Q 30/0609

(57) ABSTRACT

An automated motor vehicle department transaction system (AMVDTS) and methods of its use can validate customers and documents submitted by customer. An AMVDT can assist customers in locating MVD resources (e.g., kiosks, offices). An AMVDTS can enable the customer to select a transaction at the device from a list of services including at least one of driver's licensing, vehicle registrations, vehicle title transfers, enable the customer to provide pertinent data regarding the transaction via the device, validate at least one of the customer's identity and the pertinent data utilizing validation data resources accessible by the AMVDTS including third party records accessible from a remote server, complete the transaction for the customer utilizing the pertinent data if the customer's identity is validated and the customer provides a valid payment to the AMVDTS for the transaction, and enable printing of official documents for the customer following processing of the valid payment by the AMVDTS.

### TECHNICAL FIELD

Embodiments are generally related to systems in support of motor vehicle department operations and transactions. More particularly, embodiments are related to an automated motor vehicle department transaction system (AMVDTS) and methods of its use. Embodiments are also related to an automated motor vehicle department transaction system that can validate customers and documents submitted by customer. Embodiments are also related to an automated motor vehicle department transaction system that can assist customers in locating automated motor vehicle department transaction system.

### BACKGROUND

A department of motor vehicles (DMV) is a state-level government agency that administers vehicle registration and driver licensing. The name “DMV” is not used in every state or area. For example, the term motor vehicle department (MVD) is how the slate-level government agency is identified in the State of New Mexico. Traditional DMV functions such as driver's license issuance and renewal, vehicle registration, and vehicle transfers and titling are not exclusive handled by a single agency in every state, but the generic term is widely understood, particularly in the context of driver's license issuance and renewal. Many stales also utilize private contractors to fulfill services typically provided by their government department or agency.

Motor vehicle registration is the registration of a motor vehicle with a government authority, either compulsory or otherwise. The purpose of motor vehicle registration is to establish a link between a vehicle and an owner or user of the vehicle. This link might be used for taxation or crime detection purposes. While almost all motor vehicles are uniquely identified by a vehicle identification number, only registered vehicles display a vehicle registration plate and carry a vehicle registration certificate. Motor vehicle registration is different from motor vehicle licensing and roadworthiness certification.

In the United States, driver's licenses are issued by each individual state, territory, and the District of Columbia rather than by the federal government because of the concept of federalism. Drivers are normally required to obtain a license from their state of residence and all states recognize each other's licenses for non-resident age requirements. A state may also suspend an individual's driving privilege within its borders for traffic violations. Many states share a common system of license classes. Some states, mostly those with an international border, issue enhanced driver's licenses and enhanced ID cards. Enhanced licenses combine a regular driver's license with the specifications of the new federal passport card. Thus, in addition to providing driving privileges, the enhanced license also is proof of U.S. citizenship, and can therefore be used to cross the Canadian and Mexican borders by road, rail, or sea, although air travel still requires a traditional passport book.

Modernization of legacy systems and processes can be complex, costly, and an overdue activity for most organizations. For example, the Minnesota's Licensing and Registration System (MNLARS) project was initiated in 2008 when the Minnesota Legislature recognized that the current system that went live in 1982 was on its last legs. There was a slim hope that MNLARS would be operational by 2012, but, alas, it was not. Its final releases after tens of millions of dollars invested did not occur until about 2016-2018.

The Colorado Department of Revenue's Division of Motor Vehicles and the Colorado Governor's Office of Information Technology kicked off the Colorado Driver License, Record, Identification and Vehicle Enterprise Solution (DRIVES) project in August 2015. The system was to be deployed in two phases, with driver services scheduled to be in place in early 2017 and motor vehicle services in the second half of 2018. FAST is providing the FastDS-VS® software, implementation services, conversion, and training. FAST was also to provide complete hosting services for the system, with ongoing support for hardware and software after the system goes live. The Colorado DRIVES project is a first of its kind for DMV agencies. The system was meant to support shorter wait times at DMV offices and provide additional improvements to statewide DMV operations through system integration and modernization.

Despite system modernization and upgrading attempts, MVD systems still heavily depend on human users and can encounter problems with document validation prior to authorizing transactions. What is needed are methods and systems to automate the data collection and validation of all motor vehicle department transactions. This disclosed system and its processes can combat fraud and lengthy wait times for motor vehicle department transactions. The disclosed systems and methods can enable customers to easily locate and utilize resources to better engage in/with DMV functions.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide methods, systems, and a computer-usable medium for providing an Automated Motor Vehicle Department Transaction System (AMVDTS) that can utilize facial recognition and optical character recognition (OCR) to automate the validation of motor vehicle documentation prior to authorizing the transaction.

It is another aspect of the disclosed embodiments to provide an Automated Motor Vehicle Department Transaction System (AMVDTS) that can solve problems encountered where human clerks fail to cross reference external (i.e., government agency and third party) data sources that can be available to combat fraudulent transactions.

It is yet another aspect of the disclosed embodiment that an automation of the validation process, through software, hardware (e.g., mobile devices, kiosks), and combinations of both, can lead to much shorter wait times in a motor vehicle department state or contractor office, including a near ZERO wait time via mobile app or desktop applications.

It is yet another aspect of the disclosed embodiments that an AMVDTS can enable the customer to select a transaction at the device from a list of services including at least one of driver's licensing, vehicle registrations, vehicle title transfers, enable the customer to provide pertinent data regarding the transaction via the device, validate at least one of the customer's identity and the pertinent data utilizing validation data resources accessible by the AMVDTS including third party records accessible from a remote server, complete the transaction for the customer utilizing the pertinent data if the customer's identity is validated and the customer provides a valid payment to the AMVDTS for the transaction, and enable printing of official documents for the customer following processing of the valid payment by the AMVDTS.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 illustrates a block diagram of a system that can be utilized for processing MVD related transactions, in accordance with a preferred embodiment for an Automated Motor Vehicle Department Transaction System (AMVDTS).

FIG. 2 illustrated is a block diagram of a kiosk 201 (i.e., “MVD Kiosk”) that can be utilized for processing MVD related transactions, in accordance with a preferred embodiment for an Automated Motor Vehicle Department Transaction System (AMVDTS).

FIG. 3 illustrates a block diagram of a community (i.e., town, city) wherein a customer using a mobile device desire to find an MVD resource (e.g., MVD office, MVD Kiosk) that can be utilized for processing MVD related transactions as part of an Automated Motor Vehicle Department Transaction System (AMVDTS), in accordance with an alternative embodiment.

FIG. 4 illustrates is a flow diagram of a method for providing a motor vehicle department related services, in accordance with an embodiment.

FIG. 5 illustrates another flow diagram of a method for providing a motor vehicle department related services, in accordance with an embodiment.

### DETAILED DESCRIPTION

The particular values and configurations discussed in these non-limiting examples can be varied and are cited merely to illustrate at least one embodiment and are not intended to limit the scope thereof.

Disclosed herein are improvements for motor vehicle department operations and transactions in the form of an automated motor vehicle department transaction system (AMVDTS) including methods of its use.

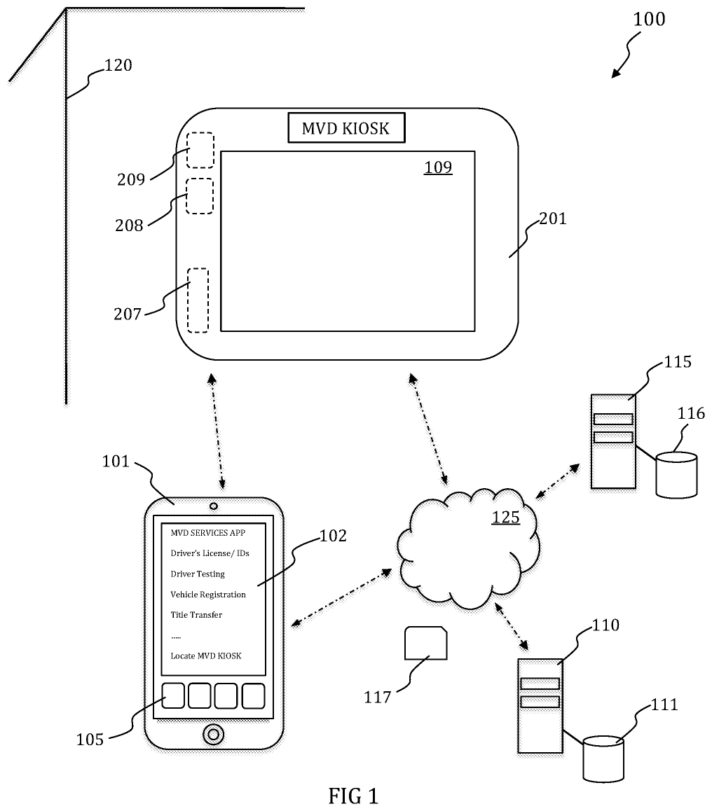

FIG. 1 illustrates a block diagram of a system 100 that can be utilized for processing MVD related transactions, in accordance with a preferred embodiment for an Automated Motor Vehicle Department Transaction System (AMVDTS). System 100 can be configured to include a control server 110 that communicates with a storage unit 111 (e.g., memory, database, etc.). System 100 can include the use of one or more device used by a customer, such as the hand held device 101 or a kiosk 201 provided for use by the customer-user, which can communicate with control server 110 through a network 125 (e.g., the Internet, cellular network, GSM, CDMA, HSPDA, Wi-Fi, WiMAX, LAN, 3G, 4G, 5G, LTE, Bluetooth, etc.). Communication to carry out MVD related transactions between, for example, a customer-user of the wireless handheld device 101 and the MVD agency or contractor via control server 110 and associated databases 111. Data provided by customers or retrieved by the MVD agency/contractor can be cross referenced with external (i.e., government agency and third party) data sources via databases 116 that can be available via the remote server 115 to validate customer identification, documents and transactions, and otherwise combat fraudulent transactions. For example, a customer can then validate their identity upon first interaction with AMVDTS by utilizing 3rd party identity validation service such as a facial recognition match against state id and license records, as well as DOD, Homeland Security, State and Federal Police Records for matches as to the validity of identity. (preventing identity theft).

System 100 can provide customers with an ability to create a remote MVD transaction using a data file 117 containing records provided from a mobile entity such as, for example, a wireless handheld device 101 or a kiosk 201 associated with an AMVDTS operator (e.g., MVD or MVD contractor). Note that records are capable of being exported into a file 117 in various formats, such as PDF, or other webform format, and can be manipulated and can be stored to a database 111 when accessed or provided online via network 125. The wireless handheld device 101 may be, for example, a cellular telephone or other mobile communication device, such as a smartphone, tablet computer, a PDA, a laptop computer, etc. It should also be understood that although a handheld device is specified in this part of the description, some applications can include the use of a desktop computer to carry out features of the embodiments. It should also be understood that some applications can also include the use of a kiosk 201 provided by a third party (e.g., MVD or MVD contractor) with respect to the customer in order to facilitate carrying out features of the embodiments. Communications can be wired or wireless. As shown by dashed arrows in the FIG. 1, communications can be supported between mobile devices 101 and networks 125 to kiosk 201, control server 110 and remote server 115 via network 125 and/or kiosk 201. Communications can be supported between mobile device 101 and kiosk 201 via communication network 125. Short range wireless communications can be supported between mobile device 101 and kiosk 201.

A application 102 (e.g., MVD Services APP) can be downloaded into a mobile device 101 to enable a customer to access to the AMVDTS and an ability to navigate using user interface 105 the services that can be provided by an AMVDTS over at least one of between the mobile device 101 and server 110 via a data network 125, and via wireless connection between a mobile device 101 and a kiosk 201 with connection to server 110. The APP 102 can provide a user with services such as Driver's License/ID application/renewal, Driver Testing, Vehicle Registration, Title Transfers, and other services typical of state MVDs.

A kiosk 201 (e.g., “MVD Kiosk”) can be provided in the form of a standalone system (e.g., unhoused and located along a street or walkway similar to a bank automated teller machine) or the kiosk 201 can be housed in a building 120. In either case, the kiosk 201 should be easily accessible within a community (e.g., town, city) by customers. Accessibility can also include an ability to locate a kiosk with respect to a user's location within a community as can be determined by GPS or network connectivity of a user's mobile device 101. A kiosk can include a power source 207 (e.g., utility connection or solar), data communications module 208 (e.g., wireless or wired connection to network 125, shortrange rf communications with mobile device 101) and physical data collection hardware 209 (explained below with respect to elements 211-216).

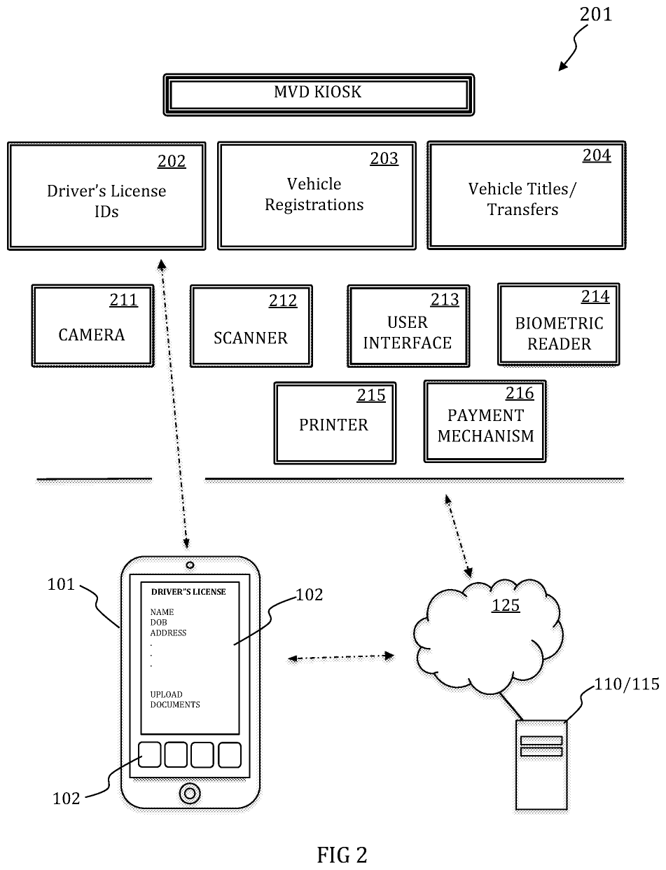

Referring to FIG. 2, illustrated is a block diagram of a kiosk 201 (i.e., “MVD Kiosk”) that can be utilized for processing MVD related transactions, in accordance with a preferred embodiment for an Automated Motor Vehicle Department Transaction System (AMVDTS). A kiosk can include service modules 202-204 that can be activated in association with a service requested/selected by a customer. A Driver's License/ID module 202 can enable customers to apply for or renew driver's licenses/IDs. A Vehicle Registrations module 203 can enable customers to register or renew registration of a motor vehicle. Vehicle Titles/Transfers module 204 can enable customers to record the purchase of a vehicle or record the transfer (e.g., sale) of a vehicle to from/to third parties. Physical data collection hardware 209 can include any of a camera 211, scanner 212, user interface 213, biometric reader 214, printer 215, payment mechanism 216. Other hardware can be included as needed to provide/accomplish services related to MVD functions. Shown in FIG. 2 is a mobile device being utilized as the user interface and wirelessly connected to the kiosk 201. A driver's license application is being displayed as an example on the mobile device 101. The mobile device is shown communicating with the kiosk 201 and servers 110/115. The App 102 can enable customers to enter information (e.g., name, date of birth, address) and upload documents for validation/verification and processing.

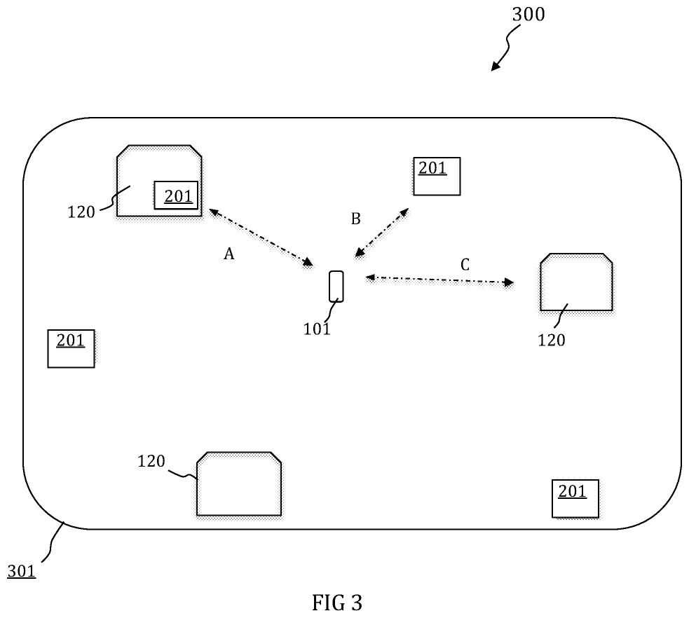

Referring to FIG. 3, illustrated is a block diagram of a community 301 (i.e., town, city) wherein a customer using a mobile device 101 desire to find an MVD resource (e.g., MVD office 120, MVD Kiosk 201) that can be utilized for processing MVD related transactions as part of an Automated Motor Vehicle Department Transaction System (AMVDTS), in accordance with an embodiment. The mobile device can utilize the APP 120 to query the AMVDTS for a kiosk 201 and/or MVD office 120 location near the mobile device 201. A location of the mobile device 101 can be determined by GPS or data network communication network connectivity (e.g., signal strength, triangulation), then MVD resources (kiosk/MVD office, or sometimes both when co-located) can be located based on a determination of the location of the mobile device 101. For example, the APP 120 as part of the AMVDTS can assist the customer in finding a kiosk 201 that is close (convenient to customer's location) and functional so that a customer does not waste time going to a kiosk that is not in working order.

It can be appreciated given the present disclosure that at least one, or any combination, of the AMVDTS, the kiosk and the mobile device programmed to enable the customer to select a transaction at the device from a list of services including at least one of driver's licensing, vehicle registrations, vehicle title transfers, enable the customer to provide pertinent data regarding the transaction via the device, validate at least one of the customer's identity and the pertinent data utilizing validation data resources accessible by the AMVDTS including third party records accessible from a remote server, complete the transaction for the customer utilizing the pertinent data if the customer's identity is validated and the customer provides a valid payment to the AMVDTS for the transaction, and enable printing of official documents for the customer following processing of the valid payment by the AMVDTS.

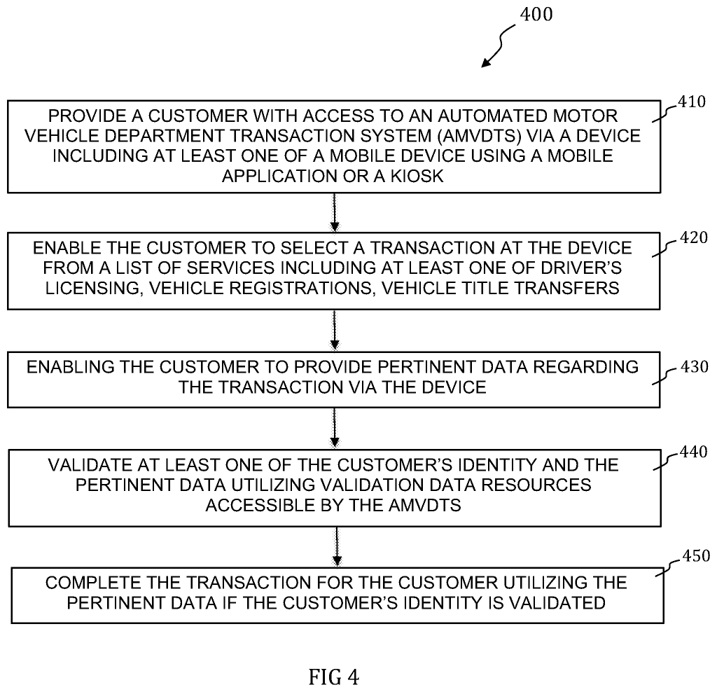

Referring to FIG. 4, illustrated is a flow diagram of a method for providing a motor vehicle department related services, in accordance with features of the embodiments. As shown in block 410, a customer can be provided with access to an automated motor vehicle department transaction system (AMVDTS) via a device including at least one of a mobile device using a mobile application or a kiosk. The customer can then be enabled to select a transaction at the device from a list of services including at least one of driver's licensing, vehicle registrations, vehicle title transfers, as shown in block 420. At block 430, the customer can be enabled to provide pertinent data regarding the transaction via the device. At block 440, at least one of the customer's identity and the pertinent data can be validated utilizing validation data resources accessible by the AMVDTS. Then, as shown in block 450, the transaction can be completed for the customer utilizing the pertinent data if the customer's identity is validated.

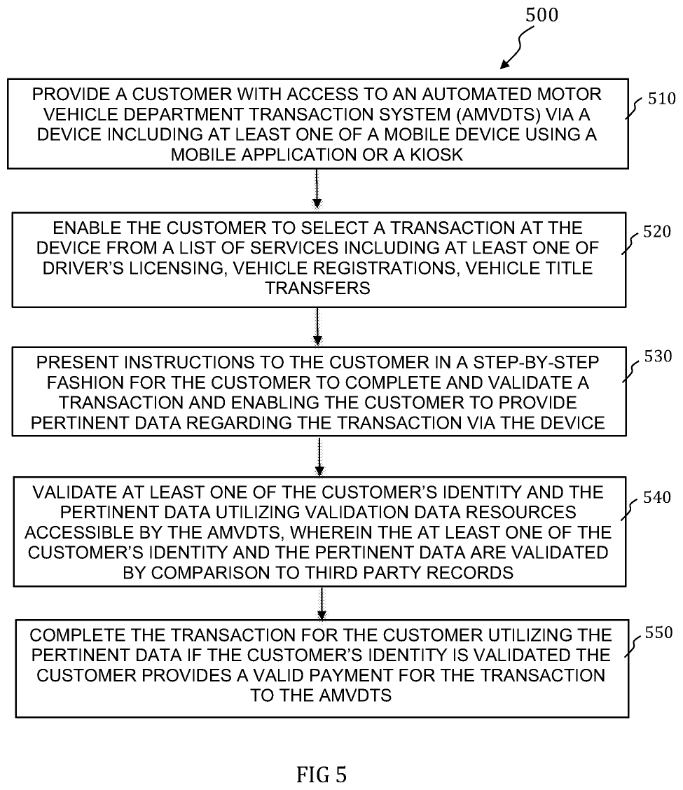

Referring to FIG. 5, illustrated is a flow diagram of a method for providing a motor vehicle department related services, in accordance with features of the embodiments. As shown in block 510, a customer can be provided with access to an automated motor vehicle department transaction system (AMVDTS) via a device including at least one of a mobile device using a mobile application or a kiosk. At block 520, the customer can be enabled to select a transaction at the device from a list of services including at least one of driver's licensing, vehicle registrations, vehicle title transfers. As shown in block 530, instructions to the customer can be presented in a step-by-step fashion for the customer to complete and validate a transaction and enabling the customer to provide pertinent data regarding the transaction via the device. At block 540, at least one of the customer's identity and the pertinent data can be validated utilizing validation data resources accessible by the AMVDTS, wherein the at least one of the customer's identity and the pertinent data are validated by comparison to third party records. Then, as shown in block 550, the transaction can be completed for the customer utilizing the pertinent data if the customer's identity is validated the customer provides a valid payment for the transaction to the AMVDTS.

It can be appreciated given this disclosure that at least one of the customer's identity and the pertinent data can be validated by comparison to third party records. Validation of customer identity can include utilizing 2-stage authentication via code entry obtained from an electronic message received on the mobile device. Validation of the customer identity utilizing the 2-stage authentication can occur upon customer access subsequent to an initial registration with the AMVDTS. The AMVDTS can determine a history or individual based on past interaction after customer validation. Also, the service selected by a customer can be presented in a step-by-step fashion to complete and validate a transaction. The service selected by the customer can include a request for documents to be uploaded into the AMVDTS, and the customer can then upload the documents. The AMVDTS can detect the quality of the documents. Optical character recognition can be used by the AMVDTS to extract text from the documents. Text extracted from the documents can be presented to the customer for validation. The documents can be further validated by comparison to third party records. A transaction can be completed for a customer upon the customer provided a valid payment to the AMVDTS. The AMVDTS can query the state for latest fees for services required via API upon successful state document validation. Official documents can be printed for the customer at a kiosk following payment. Documents can be printed by the system upon locating an available data rendering device (e.g., kiosk with a scanner and/or printer).

The AMVDTS can provide proper documentation to the state level for integration with the AMVDTS automated validation systems. While each state system can be different, the ideal method can include use of a database connected microservice allowing for a secure proxy method of querying against state records for identity validation. The described Automated Motor Vehicle Department Transaction System (AMVDTS) further differs from present technology because of its utilization of 3rd party facial recognition SLA contracts (from DOD, Homeland Security, (Local, State and Federal Police Records) and optical character recognition (OCR to automate the validation of motor vehicle documentation prior to authorizing the transaction. The Automated Motor Vehicle Department Transaction System (AMVDTS) can solve the problem of human clerks failing to cross reference all possible data sources to combat fraudulent transactions. Automation of the validation process will lead to much shorter wait times in office, and minimal wait time via mobile app, kiosk use, or desktop applications. It is in the interest of States to allow automated validity and fraud prevention checks on all motor vehicle department transactions.

It will now be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for providing a motor vehicle department related services, comprising:
providing a customer with access to an automated motor vehicle department transaction system (AMVDTS) via a device including at least one of a mobile device using a mobile application or a kiosk;
enabling the customer to select a transaction at the device from a list of services including at least one of driver's licensing, vehicle registrations, vehicle title transfers;
enabling the customer to provide pertinent data regarding the transaction via the device;
validating at least one of the customer's identity and the pertinent data utilizing validation data resources accessible by the AMVDTS; and
completing the transaction for the customer utilizing the pertinent data if the customer's identity is validated.

2. The method of claim 1, wherein providing a customer with access to an automated motor vehicle department transaction system (AMVDTS) via a device including at least one of a mobile device using a mobile application or a kiosk includes assisting the customer with locating a MVD resource including at least one of a MVD kiosk and MVD office based on a determination of the mobile device's location in a community.

3. The method of claim 1, wherein the at least one of the customer's identity and the pertinent data are validated by comparison to third party records.

4. The method of claim 1, wherein validation of customer identity includes utilizing 2-stage authentication via code entry obtained from an electronic message received on the mobile device.

5. The method of claim 1, wherein a service selected by a customer is presented in a step-by-step fashion to complete and validate a transaction, the service selected by the customer includes a request for documents to be uploaded into the AMVDTS, and the customer uploads the documents, and wherein the AMVDTS detects quality of the documents.

6. The method of claim 5, wherein optical character recognition is used by the AMVDTS to extract text from the documents and the text extracted from the documents is presented to the customer for validation.

7. The method of claim 5, wherein the documents are validated by comparison to third party records.

8. The method of claim 1, wherein a transaction is completed for a customer upon the customer provided a valid payment to the AMVDTS and official documents are printed for the customer at a kiosk following the payment.

9. A method for providing a motor vehicle department related services, comprising:
providing a customer with access to an automated motor vehicle department transaction system (AMVDTS) via a device including at least one of a mobile device using a mobile application or a kiosk;
enabling the customer to select a transaction at the device from a list of services including at least one of driver's licensing, vehicle registrations, vehicle title transfers;
presenting instructions to the customer in a step-by-step fashion for the customer to complete and validate a transaction and enabling the customer to provide pertinent data regarding the transaction via the device;
validating at least one of the customer's identity and the pertinent data utilizing validation data resources accessible by the AMVDTS, wherein the at least one of the customer's identity and the pertinent data are validated by comparison to third party records;
completing the transaction for the customer utilizing the pertinent data if the customer's identity is validated the customer provides a valid payment for the transaction to the AMVDTS.

10. The method of claim 9, wherein providing a customer with access to an automated motor vehicle department transaction system (AMVDTS) via a device including at least one of a mobile device using a mobile application or a kiosk includes assisting the customer with locating a MVD resource including at least one of a MVD kiosk and MVD office based on a determination of the mobile device's location in a community.

11. The method of claim 9, wherein validation of customer identity includes utilizing 2-stage authentication via code entry obtained from an electronic message received on the mobile device, and wherein validation of the customer identity utilizing the 2-stage authentication occurs upon customer access subsequent to an initial registration with the AMVDTS.

12. The method of claim 9, wherein the service selected by the customer includes a request for documents to be uploaded into the AMVDTS as part of the pertinent data provided by the customer, the customer uploads the documents, the AMVDTS detects quality of the documents, optical character recognition is used by the AMVDTS to extract text from the documents, and the text extracted from the documents is presented to the customer for validation.

13. The method of claim 9, wherein official documents are printed for the customer at a kiosk following the payment.

14. A system for providing a motor vehicle department related services, comprising:
an automated motor vehicle department transaction system (AMVDTS) including a control server and access to at least one database containing records;
a device including at least one of a mobile device using a mobile application or a kiosk providing a customer with access to the AMVDTS via a data network, wherein at least one of the AMVDTS, the kiosk and the mobile device programmed to;
enable the customer to select a transaction at the device from a list of services including at least one of driver's licensing, vehicle registrations, vehicle title transfers;
enable the customer to provide pertinent data regarding the transaction via the device;
validate at least one of the customer's identity and the pertinent data utilizing validation data resources accessible by the AMVDTS including third party records accessible from a remote server;
complete the transaction for the customer utilizing the pertinent data if the customer's identity is validated and the customer provides a valid payment to the AMVDTS for the transaction; and
enable printing of official documents for the customer following processing of the valid payment by the AMVDTS.

15. The method of claim 14, wherein validation of customer identity includes utilizing 2-stage authentication via code entry obtained from an electronic message received on the mobile device.

16. The method of claim 15, wherein validation of the customer identity utilizing the 2-stage authentication occurs upon customer access subsequent to an initial registration with the AMVDTS.

17. The method of claim 14, wherein a service selected by a customer is presented in a step-by-step fashion to complete and validate a transaction and includes a request for documents to be uploaded into the AMVDTS.

18. The method of claim 17, wherein the AMVDTS detects quality of the documents.

19. The method of claim 19, wherein optical character recognition is used by the AMVDTS to extract text from the documents and the text extracted from the documents is presented to the customer for validation.

20. The method of claim 18, wherein the documents are validated by comparison to third party records.
